(19) United States
(12) Patent Application Publication
(10) Pub. No.: US 2010/0040080 A1
(43) Pub. Date: Feb. 18, 2010

(54) METHOD OF AND APPARATUS FOR ALLOCATING SUB-CHANNELS IN ORTHOGONAL FREQUENCY DIVISION MULTIPLE ACCESS (OFDMA) SYSTEM

(76) Inventors: Jung-Sun Um, Daejeon-city (KR); Sung-Hyun Hwang, Daejeon-city (KR); Chang-Joo Kim, Daejeon-city (KR); Myung-Sun Song, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 12/527,569

(22) PCT Filed: Mar. 6, 2008
(86) PCT No.: PCT/KR2008/001286

§ 371 Date: Aug. 18, 2009

Related U.S. Application Data
(60) Provisional application No. 60/893,898, filed on Mar. 9, 2007.

(30) Foreign Application Priority Data
Nov. 30, 2007 (KR) 10-2007-0123638

(51) Int. Cl. H04J 3/16

(52) U.S. Cl. 370/437

(57) ABSTRACT

A method and apparatus for allocating subchannels in an orthogonal frequency division multiple access (OFDMA) system is provided. In the method and apparatus, mixed bands in each of which adjacent subcarriers and distributed subcarriers are mixed are used to form a band of a basic physical resource. Accordingly, diversity subchannels each comprised of distributed subcarriers distributed over the whole band and band subchannels each comprised of adjacent subcarriers adjacent to parts of the band are formed in a single OFDMA symbol, thereby simultaneously and flexibly allocating subchannels to users.

### TECHNICAL FIELD

The present invention relates to a method of and apparatus for allocating subchannels in orthogonal frequency division multiple access (OFDMA) communication system, and more particularly, to a method of composing and allocating resources of a physical resource domain and a logic resource domain, from which subchannels are generated and allocated by a base station to users, in OFDMA systems, and a method and apparatus that are used when user terminals transmit and receive data via allocated subchannels.

The present invention is derived from a research project supported by the Information Technology (IT) Research & Development (R&D) program of the Ministry of Information and Communication (MIC) and the Institute for Information Technology Advancement (IITA) [2005-S-002-03, Development of cognitive radio technology for improving spectrum usage efficiency].

This application claims the benefit of Korean Patent Application No. 10-2007-0123638, filed on Nov. 30, 2007, in the Korean Intellectual Property Office, and U.S. Patent Application No. 60/893,898, filed on Mar. 9, 2007, in the United States Patent and Trademark Office, the disclosure of which is incorporated herein in its entirety by reference.

### BACKGROUND ART

OFDMA wireless communication systems classify sub-carriers defined in a frequency area of a single OFDMA symbol into frequency and time resource sets and allocate the sets to different users.

Methods of composing resources may be classified into a method of selecting subcarriers having low correlation from among the subcarriers allocated to the entire communication band and a method of selecting a set of adjacent subcarriers located in a band having good channel characteristics for each user. Hereinafter, a resource composed according to the former method is referred to as a diversity subchannel, and a resource composed according to the latter method is referred to as a band subchannel.

In the diversity subchannel composing method, a modulation type and a channel coding rate can be selected using an average Signal-to-Interference- and Noise Ratio (SINR) of the entire frequency resource. Thus, a base station does not request feedback information from a user about each band of a frequency resource. A diversity subchannel is suitable for user terminals having channel characteristics of large time and frequency selective fading, namely, user terminals that is far away from a base station or are highly movable.

In the band subchannel composing method, each user terminal may measure channel characteristics of a signal received from a base station and select bands having the best channel information (for example, an SINR), thereby requesting allocation of adjacent subcarriers included in the selected bands. At this time, a modulation method and a channel coding rate that are suitable for each of the SINRs of the bands can be used. Therefore, the band subchannel composing method can maximize a data transmission rate compared with the diversity subchannel composing method in which an average SINR is used. However, an overhead may be generated because channel information about bands having good channels from among all of the bands needs to be fed back to the base station. Accordingly, the band subchannel composing method is suitable for a fixed or low-speed user environment where a channel rarely changes.

### DISCLOSURE OF INVENTION

### Technical Problem

Each of the two types of subchannel composing methods may be applied to each of a time resource and a frequency resource. However, the use of one type of subchannel composing method in the entire physical resource may decrease the efficiency of the resource usage.

To address this problem, a method of using both band subchannels and diversity subchannels in time and frequency resources has been proposed. However, when two types of subchannels are both used in a time domain, different users need to be allocated for different times. In addition, when no different users desire all of the bands of the entire frequency band in a symbol to which band subchannels are allocated, some of the bands may not be used, or even bands having low SINRs may be allocated. This leads to a reduction of the efficiency of resources and transmission efficiency. On the other hand, when two types of subchannels are both used in a frequency domain, although channels and allocation methods suitable for different users can be used even in a single OFDMA symbol, an allocation of a relatively large number of band subchannels may cause a reduction of the diversity gains of diversity channels. When subcarriers to be allocated to compose diversity subchannels exist, the degree of freedom of composing band subchannels may be restricted.

### Technical Solution

In order to achieve an object of the present invention, the invention provides a method of composing a basic physical resource and a logical resource that constitute subchannels so that subchannels can be flexibly and simultaneously allocated to users.

Other objects and advantages of the present invention will be clearly understood through embodiments of the present invention described below. The objects and advantages of the present invention can be achieved by elements and a combination thereof as stated in the claims.

### ADVANTAGEOUS EFFECTS

According to the present invention, due to the use of mixed bands in constituting a band of a basic physical resource which compose subchannels, diversity subchannels and band subchannels are simultaneously allocated to the frequency domain. Therefore, a frequency resource can be flexibly and efficiently used according to the environments of users.

In addition, by combining adjacent subcarriers included in a plurality of mixed bands while improving the diversity characteristics, a band subchannel which satisfies the number of subcarriers requested to compose a subchannel can be formed even in a single OFDMA symbol. In particular, when the subcarriers of a diversity subchannel performs frequency hopping along the time resource (that is, OFDMA symbols of a time domain), the diversity characteristics can be maximized.

Moreover, by controlling the ratio in which distributed subcarriers and adjacent subcarriers are allocated to a mixed band, the ratio of diversity subchannels to band subchannels can be flexibly controlled even when the whole frequency band is comprised of only mixed bands.

### DESCRIPTION OF DRAWINGS

The above and other features and advantages of the present invention will become more apparent by describing in detail exemplary embodiments thereof with reference to the attached drawings in which:

FIG. 1 illustrates a resource composing and allocating method in an orthogonal frequency division multiple access (OFDMA) system, according to an embodiment of the present invention;

FIGS. 2A and 2B illustrate various methods composing band subchannels according to an embodiment of the present invention;

FIG. 3 illustrates different types of structures of a mixed band according to an embodiment of the present invention;

FIGS. 4A and 4B illustrate physical bands required to compose band subchannels and diversity subchannels, according to an embodiment of the present invention;

FIGS. 5A and 5B illustrate examples in which frequency hopping is applied to subcarriers that constitute a diversity subchannel, according to an embodiment of the present invention;

FIG. 6 illustrates an example in which different types of subchannels are allocated according to the locations of users, according to an embodiment of the present invention;

FIG. 7 illustrates channel characteristics of a signal received from a base station, wherein the channel characteristics are measured by a user, according to an embodiment of the present invention;

FIG. 8 illustrates a message structure that can minimize the amount of channel information that a user is to transmit to a base station, according to an embodiment of the present invention;

FIG. 9 is a flowchart illustrating a subchannel allocating method for data transmission and reception in an OFDMA system, according to an embodiment of the present invention;

FIG. 10 is a flowchart illustrating a method for user terminals to receive band subchannels from a base station, according to an embodiment of the present invention;

FIG. 11 is a block diagram for describing a structure and operation of a subchannel allocating apparatus of a base station and a structure and operation of a user terminal, according to an embodiment of the present invention;

FIG. 12 illustrates a mixed band of type 1 according to an embodiment of the present invention;

FIGS. 13A through 13C illustrate compositions of a mixed band and a subchannel according to an embodiment of the present invention;

FIGS. 14A and 14B illustrate a channel estimation method according to an embodiment of the present invention;

FIG. 15 illustrates band adaptive modulation and coding (AMC) in a standard 802.16; and

FIGS. 16A and 16B are graphs showing data transmission efficiency obtained by a subchannel allocating method according to the present invention and data transmission efficiency obtained by a subchannel allocating method supported by a standard 802.16.

### BEST MODE

In the method according to the present invention, a physical frequency resource is divided into a plurality of bands, and mixed bands are used and included in the bands. According to various channel environments of users, band subchannels each comprised of adjacent subcarriers included in specific bands and diversity subchannels each comprised of distributed subcarriers distributed over the whole frequency domain are simultaneously allocated to the whole frequency resource.

Thus, even when a larger number of band subchannels than diversity subchannels are allocated, the diversity subchannels allow a diversity gain to be maintained. In addition, the whole frequency resource can be flexibly composed of a combination of various band subchannels or diversity subchannels.

According to an aspect of the present invention, there is provided a subchannel allocating method for data transmission and reception in an orthogonal frequency division multiple access (OFDMA) system, the method comprising: dividing a whole frequency band into a plurality of bands and allocating adjacent subcarriers and distributed subcarriers to each of the bands in a predetermined ratio; and, forming a band subchannel comprised of adjacent subcarriers included in at least one band selected from among the plurality of bands and a diversity subchannel comprised of distributed subcarriers.

According to another aspect of the present invention, there is provided a data transceiving method performed by a terminal in an OFDMA system, the method comprising receiving one of a band subchannel and a diversity subchannel from a base station and transmitting data to and receiving data from the base station via the received subchannel, wherein the band subchannel is comprised of adjacent subcarriers of at least one band selected from among a plurality of bands and the diversity subchannel is comprised of distributed subcarriers, each of the plurality of bands comprise adjacent subcarriers and distributed subcarriers in predetermined ratio.

According to another aspect of the present invention, there is provided a subchannel allocating apparatus for data transmission and reception in an OFDMA system, the apparatus comprising: a band composing unit dividing a whole frequency band into a plurality of bands and allocating adjacent subcarriers and distributed subcarriers to each of the bands in a predetermined ratio; and, a subchannel forming unit forming a band subchannel comprised of adjacent subcarriers included in at least one band selected from among the plurality of bands and a diversity subchannel comprised of distributed subcarriers.

According to another aspect of the present invention, there is provided a data transceiving terminal in an OFDMA system, the terminal comprising a transceiving unit receiving one of a band subchannel and a diversity subchannel from a base station and transmitting data to and receiving data from the base station via the received subchannel, wherein the band subchannel is comprised of adjacent subcarriers of at least one band selected from among a plurality of bands and the diversity subchannel is comprised of distributed subcarriers, each of the plurality of bands comprise adjacent subcarriers and distributed subcarriers in predetermined ratio.

According to another aspect of the present invention, there is provided a computerreadable recording medium having embodied thereon a program for executing a subchannel allocating method for data transmission and reception in an orthogonal frequency division multiple access (OFDMA) system and a data transceiving method performed by a terminal in an OFDMA system.

### MODE FOR INVENTION

The present invention will now be described more fully with reference to the accompanying drawings, in which exemplary embodiments of the invention are shown. It will be understood that the same elements in the drawings are represented by the same reference numbers or characters. In the description of the present invention, if it is determined that a detailed description of commonly-used technologies or structures related to the invention may unnecessarily obscure the subject matter of the invention, this detailed description will be omitted.

It will be further understood that the terms ‘comprises (or includes)’ and/or ‘comprising (or including),’ when used in this specification, specify the presence of stated features, integers, steps, operations, elements, and/or components, but do not preclude the presence or addition of one or more other features, integers, steps, operations, elements, components, and/or groups thereof.

The present invention relates to a resource allocating method in an orthogonal frequency division multiple access (OFDMA) system. More specifically, the present invention proposes a method of composing a basic physical resource which constitutes each subchannel, and a method of forming subchannels, by which a diversity subchannel comprised of subcarriers distributed over the whole frequency band and a band subchannel comprised of adjacent subcarriers in a portion of the whole frequency band are mixed and simultaneously and flexibly allocated to each user. In other words, the present invention proposes a method of composing bands of a physical frequency resource and a method of forming subchannels, by which the advantages of the two types of subchannels can be efficiently utilized according to the channel environments of users compared with a conventional art.

The present invention relates to the structure of a mixed resource composition for wireless regional area network (WRAN) systems. The mixed resource composition is subchannelization which is composed of both adjacent subcarrier permutation and distributed subcarrier permutation on a 6 MHz TV channel simultaneously. The structure of the mixed resource composition according to the present invention is appropriate to WRAN system which is fixed channel environments and has a large cell coverage.

The cell coverage (typically, 33 km) of a WRAN is large. A channel response with customer premise equipments (CPEs) close to a base station is very different from a channel response with CPE existing on a cell edge. Since CPEs are fixed, the channel of each CPE does not change for a significant amount of time. CPE close to a base station can have improved throughput performance by using adjacent subcarrier permutation with a band subchannel (e.g., adaptive modulation and coding (AMC) subchannel). Accordingly, it is effective to allocate a good portion of a channel to the CPE close to the base station and allocate remainder subcarriers of the channel to CPE located far from the base station with distributed subcarrier permutation while maintaining frequency diversity.

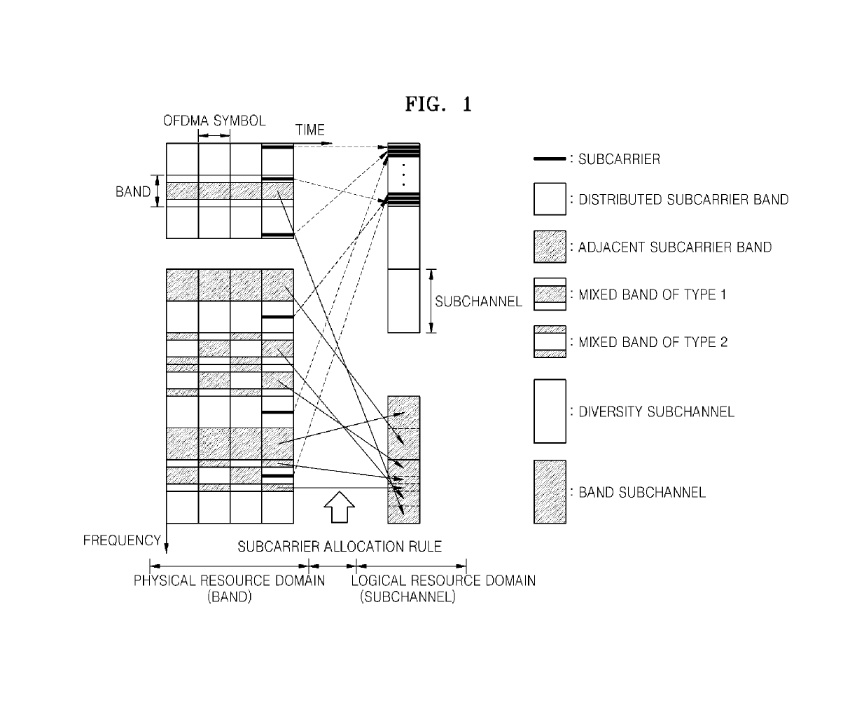

FIG. 1 illustrates a resource composing and allocating method performed in an OFDMA system, according to an embodiment of the present invention.

A frequency domain is represented by a plurality of subcarriers that constitute a OFDMA symbol, and a time domain is represented by a plurality of OFDMA symbols. Indices for distinguishing the locations of allocated subcarriers from one another (hereinafter, referred to as subcarrier indices) may be allocated to the respective locations of the subcarriers of the frequency domain.

Referring to FIG. 1, in order to compose subchannels in a logical resource domain, the physical channel (i.e., a physical resource domain) of the frequency domain is divided into a plurality of bands having identical sizes. Each band is composed of a plurality of subcarriers. The size of each band (i.e., the number of subcarriers included in each band) may vary according to the environments of systems and the managing policies of the systems. However, one or more bands should include at least a number of subcarriers that can constitute a single subchannel.

The bands are classified into three types, namely, an adjacent subcarrier band whose adjacent sub-carriers all serve as a part of a band subchannel, a distributed subcarrier band whose subcarriers serve as parts of different diversity subchannels, that is, a distributed subcarrier band comprised of distributed subcarriers, and a mixed band obtained by mixing the two above-described band characteristics. The three types of bands can be effectively and flexibly allocated to the frequency domain according to the channel information about each user and the resource allocation environment of a current system.

According to the present invention, mixed bands are used so that a band subchannel can be simply composed of adjacent subcarriers included in a plurality of mixed bands while improving diversity characteristics, although a diversity subchannel and a band subchannel are both allocated to a single OFDMA symbol. In addition, diversity subchannels and band subchannels are both allocated to the frequency domain, so that each user can efficiently and flexibly use a suitable frequency resource.

The mixed bands are classified into two types according to the locations of adjacent subcarriers within a mixed band. Only mixed bands of type 1 or only mixed bands of type 2 may be allocated and arranged in a single OFDMA symbol, or both the mixed bands of types 1 and 2 may be allocated and arranged therein. Only mixed bands of type 1 or only mixed bands of type 2 may be allocated and arranged in a single band, or the mixed bands of types 1 and 2 may be alternately allocated and arranged therein. These compositions may vary according to the resource allocation algorithm and policy of a base station or the current operating environment of a system. Since an identical modulation method and an identical coding rate can be applied to bands transmitted by a user to a base station by using identical average Signal to Interference plus Noise Ratio (SINR) information, the transmission rate of a band subchannel is prevented from changing depending on the type of mixed band.

Distributed subcarriers and adjacent subcarriers included in three types of bands defined in the physical resource domain are rearranged into two types, namely, diversity subchannels and band subchannels within a logical resource domain according to a subcarrier mapping rule that is predefined in a system.

A diversity subchannel is formed by collecting distributed subcarriers which are included in distributed subcarrier bands and mixed bands. The number of subcarriers included in a single diversity subchannel may vary according to the environments of systems and the managing policies of the systems. One or more bands should include at least a number of subcarriers that can constitute a single diversity subchannel.

A band subchannel is formed by collecting adjacent subcarriers that are included in adjacent subcarrier bands or mixed bands. The number of subcarriers included in a single band subchannel is equal to the number of subcarriers included in a single diversity subchannel.

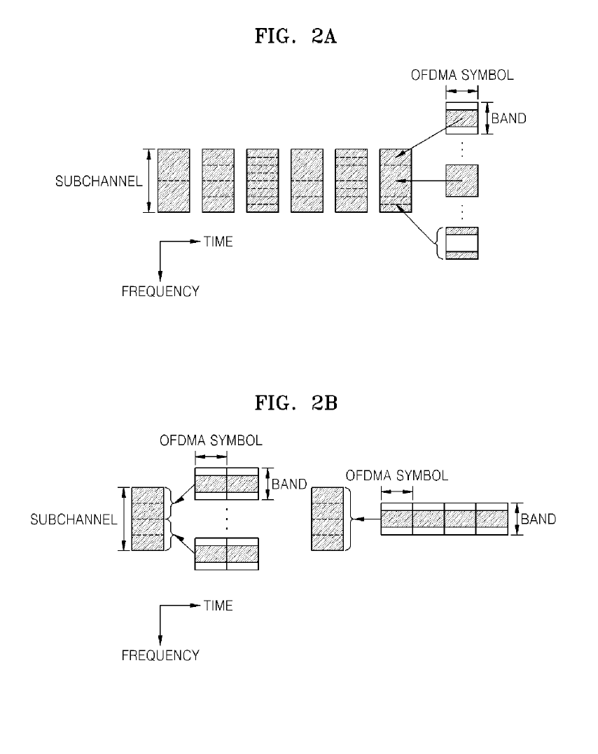

FIGS. 2A and 2B illustrate various methods composing band subchannels according to an embodiment of the present invention.

The number of adjacent subcarrier bands required to compose a band subchannel may vary according to the number of subcarriers that constitute a band. The number of bands required to compose a band subchannel may vary according to the number of adjacent subcarriers included in a mixed band. Each of the numbers of adjacent subcarrier bands and mixed bands that are required to compose various types of band subchannels may also vary according to how adjacent subcarrier bands and mixed bands are mixed. Various ways of composing a band subchannel may be defined.

As illustrated in FIG. 2A, adjacent subcarriers required to compose a single band subchannel may be collected from adjacent subcarrier bands and/or mixed bands within a single OFDMA symbol. As illustrated in FIG. 2B, the adjacent subcarriers required to compose a single band subchannel may be collected from adjacent subcarrier bands and/or mixed bands within at least one OFDMA symbol that is arranged in a band. If the number of terminals to which diversity subchannels are to be allocated is large and the number of terminals to which band subchannels are to be allocated is small, the adjacent subcarriers required to compose a single band subchannel may be collected from adjacent subcarriers within at least one OFDMA symbol in a predetermined portion of the time domain.

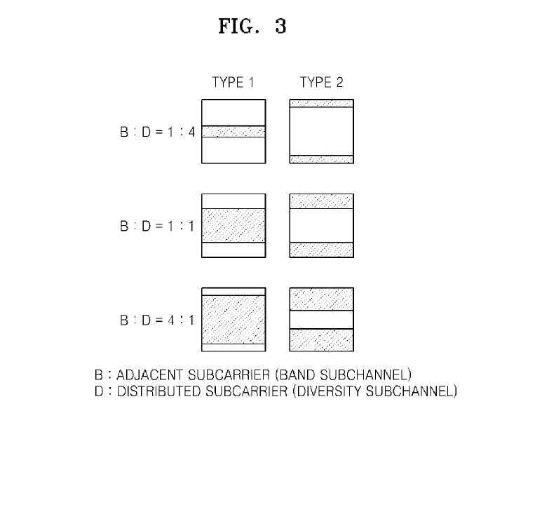

FIG. 3 illustrates different types of structures of a mixed band according to an embodiment of the present invention.

A mixed band is a combination of distributed subcarriers and adjacent subcarriers. The ratio of distributed subcarriers to adjacent subcarriers may be adjusted. If the whole frequency band is composed of only mixed bands, the allocation ratio of band subchannels to diversity subchannels may be controlled to be 1:1 according to the ratio of distributed subcarriers to adjacent subcarriers in a mixed band. Thus, the ratio of band subchannels to diversity subchannels may be flexibly defined according to the ratio of distributed subcarriers to adjacent subcarriers in a mixed band.

More specifically, FIG. 3 illustrates embodiments in which two types of mixed bands each have adjacent subcarriers B and distributed subcarriers D in ratios of 1:4, 1:1, and 4:1. When the resources of the whole frequency domain are comprised of only mixed bands, a ratio of band subchannels to diversity subchannels is determined according to the B:D ratios. On the other hand, when distributed subcarrier bands and adjacent subcarrier bands are mixed to compose the resources of the whole frequency domain, the resources can be flexibly used according to the environments of systems and resource allocation methods of base stations.

FIGS. 1 and 2A illustrate an embodiment in which a ratio of adjacent subcarriers B to distributed subcarriers D included in a mixed band is 1:1.

Various types of mixed bands such as a mixed band in which bin/2 distributed subcarriers constitute only one end may also be considered according to the system environments, etc.

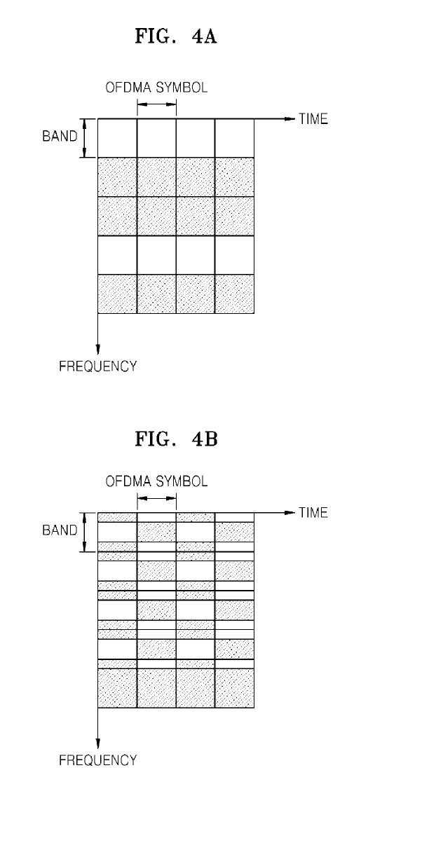

FIGS. 4A and 4B illustrate physical bands required to compose band subchannels and diversity subchannels, according to an embodiment of the present invention.

FIG. 4A illustrates physical bands including only adjacent subcarrier bands and distributed subcarrier bands. In the present invention, since diversity subchannels and band subchannels are both allocated to an existing frequency domain, if more band subchannels than diversity subchannels are required to be used and only adjacent subcarrier bands without mixed bands are allocated as illustrated in FIG. 4A, the types of frequency resources that can be allocated to compose diversity subchannels are restricted to specific bands. In this case, since the bands including subcarriers that compose diversity subchannels are restricted to specific bands, a diversity gain may decrease. In particular, if distributed subcarrier bands are allocated to a deep fading portion of the frequency domain when the coherent bandwidth of the frequency domain is greater than a predetermined band, the performance of diversity subchannels may degrade more.

FIG. 4B illustrates physical bands including not only adjacent subcarrier bands and distributed subcarrier bands but also mixed bands. Subcarriers that constitute a diversity subchannel can be selected from four mixed bands as illustrated in FIG. 4B that may have different channel environments. Accordingly, a high diversity gain can be obtained in the physical bands of FIG. 4B compared with the physical bands of FIG. 4A.

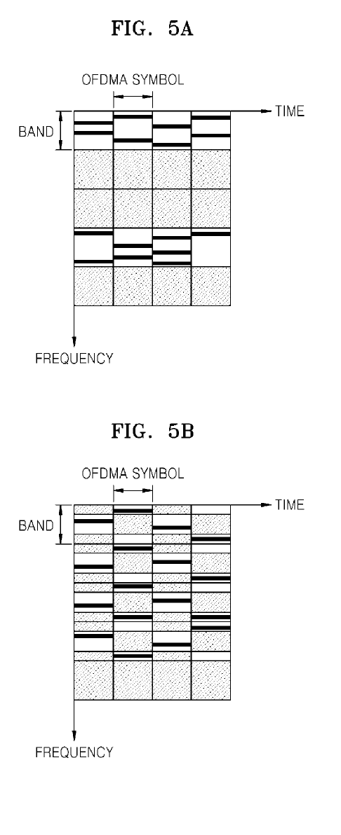

FIGS. 5A and 5B illustrate examples in which frequency hopping is applied to subcarriers that constitute a diversity subchannel, according to an embodiment of the present invention.

When frequency hopping by which subcarrier indices of subcarriers that constitute a single diversity subchannel are different in each OFDMA symbol is used, possible subcarrier indices are limited to two distributed subcarrier bands in the case of FIG. 5A where physical bands comprise only adjacent subcarrier bands and distributed subcarrier bands. On the other hand, in the case of FIG. 5B where physical bands comprise not only adjacent subcarrier bands and distributed subcarrier bands but also mixed bands, subcarrier indices may be hopped to various bands within two OFDMA symbols. Thus, the case of FIG. 5B can obtain a higher gain depending on the frequency hopping than the case of FIG. 5A. If the entire frequency resource is comprised of only mixed bands, frequency hopping is possible in the whole frequency band within two OFDMA symbols.

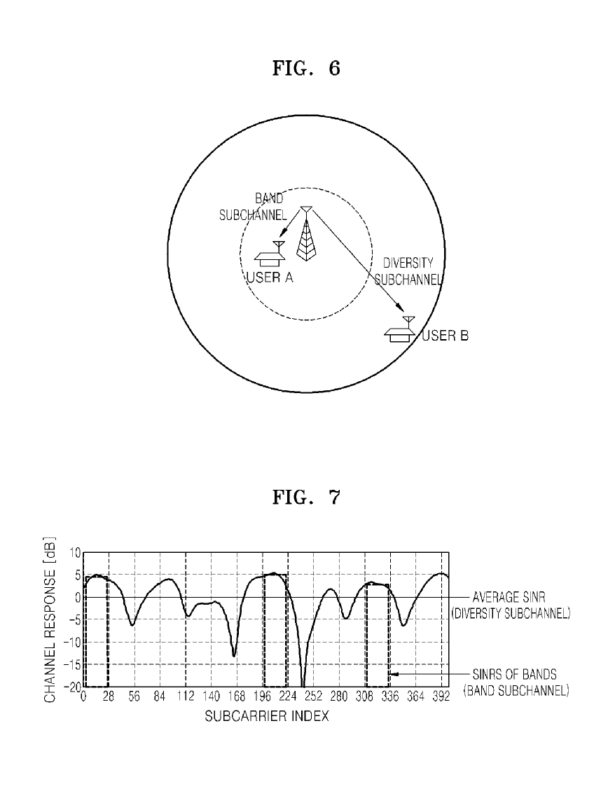

FIG. 6 illustrates an example in which different types of subchannels are allocated according to the locations of users, according to an embodiment of the present invention.

In a method of simultaneously composing two types of subchannels in a frequency domain according to the present invention, if allocated bands that constitute a subchannel continuously vary according to time, an overhead of feedback information and complexity of scheduling of a base station may be caused. Accordingly, this composition method is suitable for environments where channels do not change much temporally, namely, low-speed environments where users are fixed or rarely move.

In addition, in the simultaneous composition method, in the case of users to which two different types of subchannels are allocated, it is efficient as illustrated in FIG. 6 that a band subchannel be allocated to a user A close to a base station and a diversity subchannel be allocated to a user B far away from the base station.

FIG. 7 illustrates channel characteristics of a signal received from a base station, wherein the channel characteristics are measured by a user, according to an embodiment of the present invention.

More specifically, FIG. 7 illustrates channel characteristics and an estimated signal to interference plus noise ratio (SINR) of a frequency domain of a signal received in a system in which 28 subcarriers are set in a single band. A diversity subchannel may define a modulation type and a channel coding rate by using an average SINR value. For a band subchannel, user may inform a base station of identification of bands with relatively high SINRs and the SINRs of the bands and request the base station to allocate the bands as bands that constitute a band subchannel. In this case, as the number of bands defined in the frequency domain is large, the amount of channel information required to transmit information about the SINRs of the bands may increase. Thus, a message structure for minimizing the amount of information required to transmit the SINR information about the bands is needed.

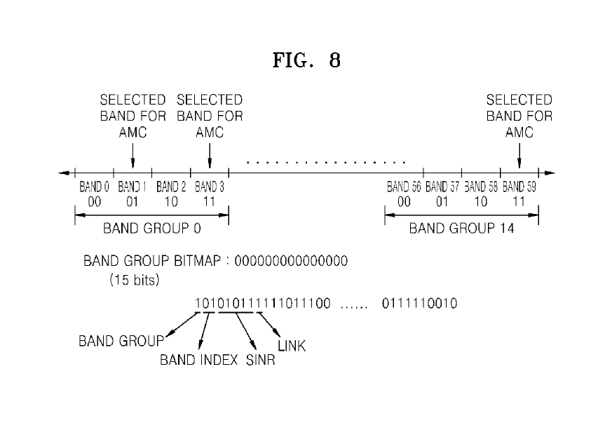

FIG. 8 illustrates a message structure that can minimize the amount of channel information that a user is to transmit to a base station, according to an embodiment of the present invention.

All users need to know the locations of bands that are to be used to constitute a band subchannel. Accordingly, an MAP message through which feedback channel information is transmitted needs to include information about whether the message structure is identical with a previous frame or subframe, the number of selected mixed bands, the locations of the selected bands, etc.

FIG. 8 illustrates a method of minimizing the amount of information when the number of bands to be transmitted is 15 or less under the assumption that 60 bands exist. First, a user terminal divides the 60 bands into 15 band groups, and allocates 2 bits in order to indicate 4 bands that constitute each band group. When the user terminal selects a band having a good SINR (for example, maximum SINR), a bit for a band group that includes the selected band is defined as 1, and 8 bits indicate the location of the selected band, the SINR thereof, and whether a selected band other than the selected band exists in the corresponding band group. One or more band having a good SINR may be selected for AMC subchannel. The 8 bits is selected for only example to explain the embodiment, the number of bits may vary according to the number of bits that represent the SINR. And the 8 bits may be transmitted by being attached directly to a bitmap for 15 band groups. The SINRs of bands may be transmitted individually, or an average SINR may be transmitted for several bands. For example, if 8 bits are used to indicate the location of the selected band, the SINR thereof, and whether a selected band other than the selected band exists in the corresponding band group, the total number of bits required is [15+(8× the number of bands to be reported)]. Such feedback channel information may be periodically transmitted in consideration of a cycle in which a channel varies according to the time or in consideration of a frame structure of a system. The feedback channel information may be transmitted in the form of an identical structure or other simplified structures in consideration of a feedback process of a WRAN. The number of band groups may be suitably determined in consideration of the amount of data to be transmitted, wireless resources, etc. Accordingly, when the number of bands that the user terminal is to report is small, all of the bands are divided into groups, and indices of the bands included in each group are transmitted. Consequently, the overhead of the feedback information is minimized.

When the number of bands to be reported is large, a user terminal may transmit the band indices designated for all of the bands without grouping the bands. Also, a band environment and other factors may be considered to decide whether grouping the bands is performed or not, and the manner of transmitting the band indices. It will be understood by those of ordinary skill in the art that the present invention is not limited to the above-described method, and other various methods for minimizing the overhead may be used.

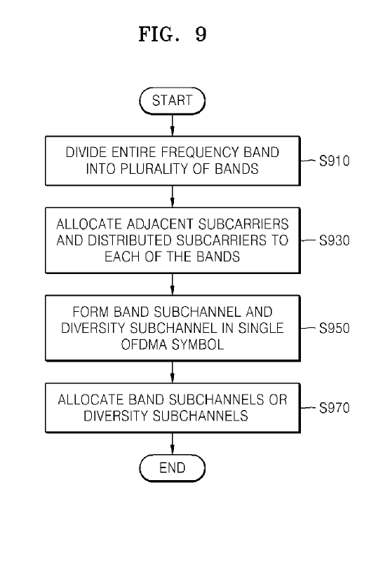

FIG. 9 is a flowchart illustrating a subchannel allocating method for data transmission and reception in an OFDMA system, according to an embodiment of the present invention.

Referring to FIG. 9, a base station allocates subcarriers to a plurality of bands that constitute a physical resource domain in order to perform sub-channel allocation, and allocates the subcarriers of the bands to a logical resource domain in order to form two subchannels in a single OFDMA symbol.

The sub-channel allocation may be performed in a specific subchannel allocation method by a base station at the request of a user or without a user's request. As described above, when desiring to allocate a band subchannel, the base station needs to receive channel status information in advance from a user terminal.

In operation S910, the base station divides the whole frequency band into a plurality of bands. In operation S930, adjacent subcarriers and distributed subcarriers are allocated to each of the bands in a predetermined ratio. According to allocation ratios, the bands are classified into an adjacent subcarrier band comprised of adjacent subcarriers, a distributed subcarrier band comprised of distributed subcarriers, and a mixed band comprised of both adjacent subcarriers and distributed subcarriers. After receiving a band subchannel requesting message including band information from a user terminal (or a CPE), the base station selects bands requested by the user terminal by referring to the band information and forms the selected bands of either adjacent subcarrier bands or mixed bands according to, for example, the selected bands characteristics.

In operation S950, the base station forms a band subchannel and a diversity subchannel in a single OFDMA symbol. The base station allocates adjacent subcarriers included in the requested bands in order to form a band subchannel. The base station allocates distributed subcarriers in order to form a diversity subchannel. The distributed subcarriers are distributed subcarriers included in mixed bands which belong to the requested bands and distributed subcarrier bands. A ratio in which band subchannels and diversity subchannels are formed may be controlled by a change of the ratio in which adjacent subcarriers and distributed subcarriers are allocated to each band.

In operation S970, the base station allocates band subchannels or diversity subchannels to the user terminal according to the user's environment or at the request of the user. The base station may allocate band subchannels to a user terminal close to the base station and diversity subchannels to a user terminal far away from the base station.

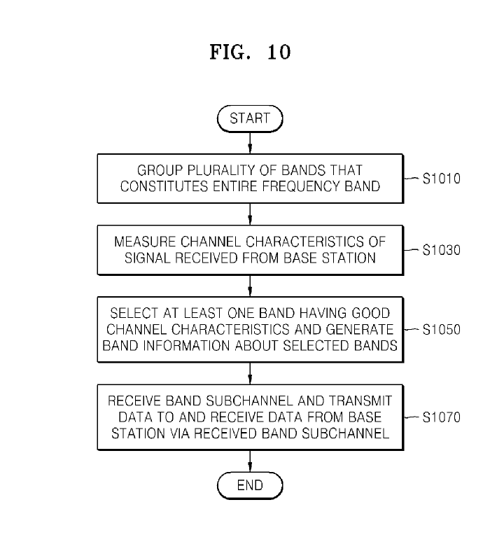

FIG. 10 is a flowchart illustrating a method for user terminals to receive band subchannels from a base station, according to an embodiment of the present invention.

A user terminal receives band subchannel or diversity subchannel from a base station and transmits data to and receives data from the base station via the received subchannel. The band subchannels are composed of adjacent subcarriers that are included in adjacent subcarrier bands or mixed bands. The diversity channels are composed of distributed subcarriers that are included in distributed subcarrier bands and mixed bands.

The user terminal may receive the band subchannel from the base station by making a request for allocating band subchannel together with band information and channel characteristic information. Alternatively, the user terminal may receive the band subchannel from the base station according to channel characteristics information provided by the user terminal in response to a request for the channel characteristics information from the base station. The band information is generated according to a method of minimizing an overhead. FIG. 10 illustrates a method of grouping bands and generating band information in order to minimize the overhead.

Referring to FIG. 10, in order to minimize an overhead when transmitting band channel information in order to receive band subchannel, first, a user terminal groups a plurality of bands that constitutes the whole frequency band, thereby generating a plurality of band groups, in operation S1010.

In operation S1030, the user terminal measures channel characteristics of a signal received from the base station. An SINR may be used as the channel characteristics of the received signal.

In operation S1050, the user terminal selects at least one band having good channel characteristics from among all of the frequency bands, and generates band information about the selected bands (for example, the bands having relatively high values of channel characteristics). The band information includes indices of the selected bands and the measured channel information thereof.

In operation S1070, the user terminal transmits a message including the band information to the base station and receives a band subchannel from the base station. The band information may be periodically generated and transmitted to the base station. The user terminal transmits data to and receives data from the base station via the received band subchannel.

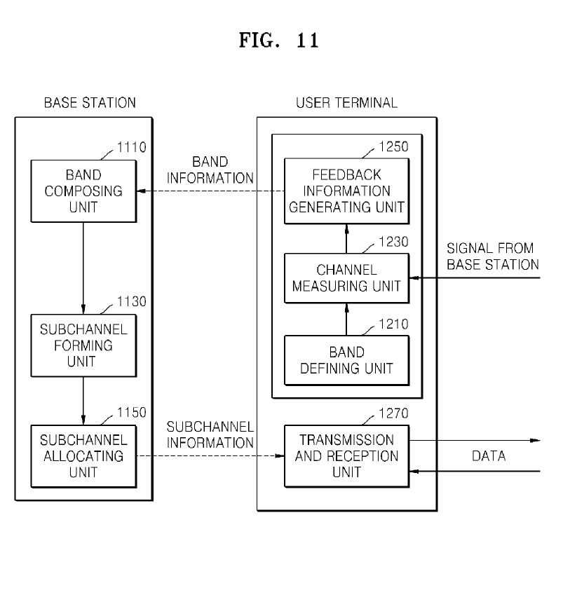

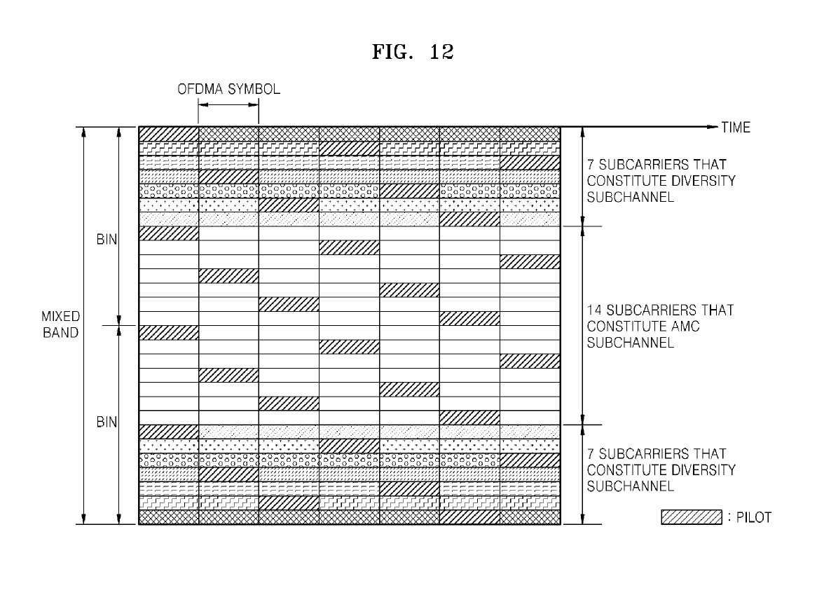

FIG. 11 is a block diagram for describing a structure and operation of a subchannel allocating apparatus of a base station and a structure and operation of a user terminal, according to an embodiment of the present invention. Referring to FIG. 11, the user terminal includes a band defining unit 1210, a channel measuring unit 1230, a feedback information generating unit 1250, and a transmission and reception unit 1270.

The band defining unit 1210 divides a plurality of bands that constitute the whole frequency band into band groups.

The channel measuring unit 1230 measures the channel characteristics of a signal received from a base station.

The feedback information generating unit 1250 selects at least one band having good channel characteristics from among all of the frequency bands of the received signal, generates band information about the selected bands, and transmits the band information together with a subchannel allocation requesting message to the base station.

The subchannel allocating apparatus includes a band composing unit 1110, a subchannel forming unit 1130, and a subchannel allocating unit 1150.

The band composing unit 1110 composes each of the bands of one of an adjacent subcarrier band, a distributed subcarrier band, and a mixed band. The band composing unit 1110 may change a ratio in which adjacent subcarriers and distributed subcarriers are allocated to each band, in order to control a ratio in which band subchannels and diversity subchannels are formed. The band composing unit 1110 receives the band information including channel characteristics information from the user terminal and composes the selected bands included in the band information of adjacent subcarrier bands or mixed bands.

The subchannel forming unit 1130 forms band subchannels composed of adjacent subcarriers included in the bands and diversity subchannels composed of distributed subcarriers included in the bands. The subchannel forming unit 1130 forms a band subchannel by allocating the adjacent subcarriers included in the selected bands which are adjacent subcarrier bands or mixed bands. The subchannel forming unit 1130 forms a diversity subchannel by allocating the distributed subcarriers included in the distributed subcarrier bands and the distributed subcarriers included in the selected bands which are mixed bands. At this time, the subchannel forming unit 1130 can increase the diversity gain by applying frequency hopping in which distributed subcarriers having different subcarrier indices are allocated for OFDMA symbols in a time domain.

The subchannel allocating unit 1150 allocates either a band subchannel or a diversity subchannel to the user terminal. The subchannel allocating unit 1150 allocates a subchannel composed of the selected bands to the user terminal that has transmitted the band information of the selected bands. The subchannel allocating unit 1150 may allocate the band subchannel to a user terminal close to the base station and the diversity subchannel to a user terminal far away from the base station.

The transmission and reception unit 1270 of the user terminal that has been allocated a subchannel transmits data to and receives data from the base station via the allocated subchannel.

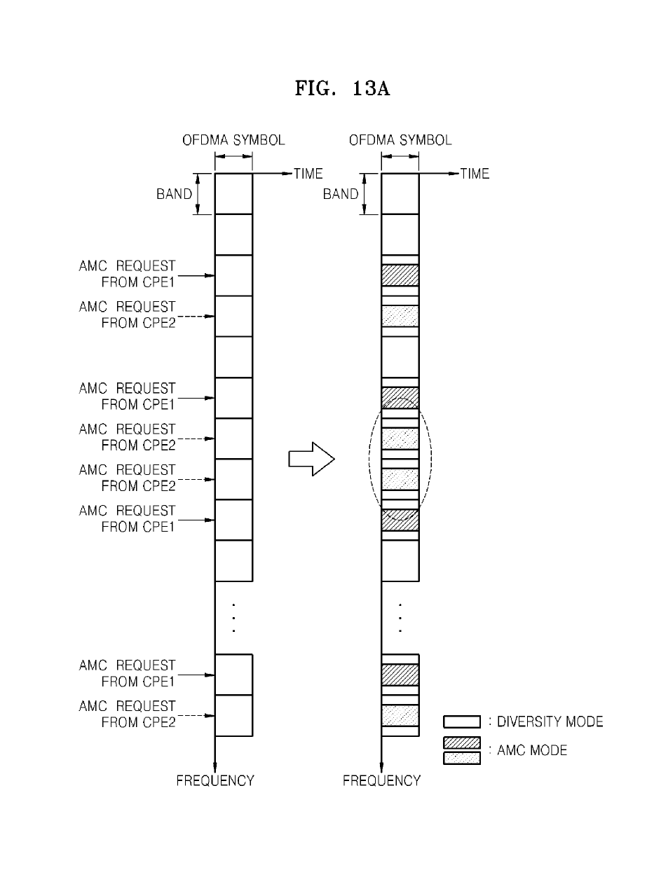

FIG. 12 illustrates a mixed band of type 1 according to an embodiment of the present invention. Hereinafter, a band-AMC (Adaptive Modulation and Coding) subchannel (hereinafter, referred to as an AMC subchannel) will be described as an example of a band subchannel.

Referring to FIG. 12, the mixed band of type 1 is comprised of 28 subcarriers, namely, two bins. A CPE informs a base station of information about the channel quality of the mixed band of type 1 having 28 subcarriers. In response to a request made by the CPE for an AMC subchannel, the base station allocates 14 adjacent subcarriers of a requested mixed band to the CPE. The base station allocates the residual subcarriers to a CPE which uses a diversity subchannel.

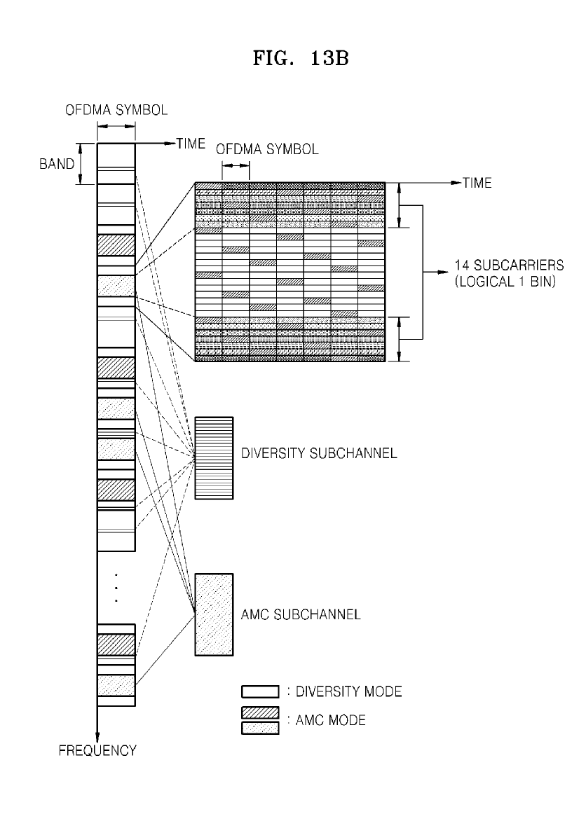

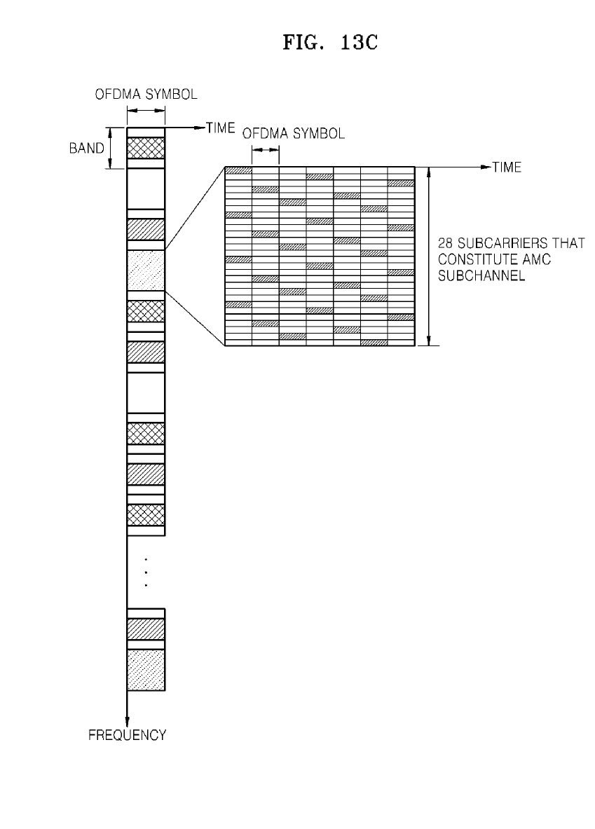

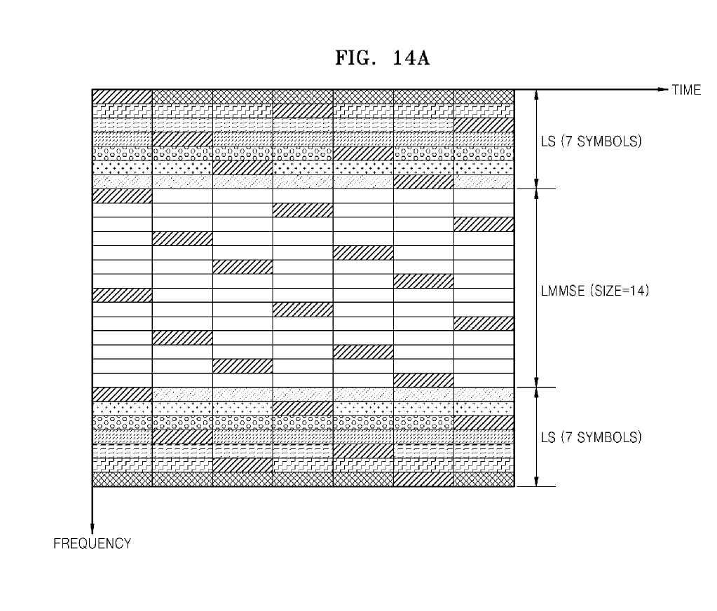

FIGS. 13A through 13C illustrate compositions of a mixed band and a subchannel according to an embodiment of the present invention.

Referring to FIG. 13A, at first, all subcarriers are used for all kinds of CPEs by using a diversity subchannel of a distributed subcarrier permutation. Thereafter, CPE1 and CPE2 transmit SNR information about a specific band to a base station in order to request an AMC subchannel. The base station selects four bands for each of the CPEs in order to form an AMC subchannel.

Referring to FIG. 13B, the AMC subchannel is comprised of adjacent subcarriers of four bands (14 adjacent subcarriers for each band), namely, 56 subcarriers (i.e., 48 data subcarriers+8 pilot subcarriers). Types of the AMC subchannel may include 4×1, 2×2, 1×4 (the number of bands×the number of OFDMA symbols), etc. A diversity subchannel aggregates the remaining subcarriers of the bands, namely, 56 subcarriers. The unit of aggregation is subcarrier and/or bin/2, namely, 7 adjacent subcarriers.

Accordingly, an AMC subchannel comprised of 4 adjacent subcarrier bands or mixed bands may have an additional diversity gain, and a diversity subchannel comprised of distributed subcarrier bands may obtain a diversity gain even in bands used to form the AMC subchannel. Thus, the degree of freedom for diversity subchannels increases.

Referring to FIG. 13C, when the number of AMC subchannel users is greater than that of diversity subchannel users, an adjacent subcarrier band instead of a mixed band is formed, all of 28 subcarriers are used to form an AMC subchannel, and the diversity subchannel is formed by using mixed bands as bands adjacent to the sides of the adjacent subcarrier band. Thus, a diversity gain can be maintained.

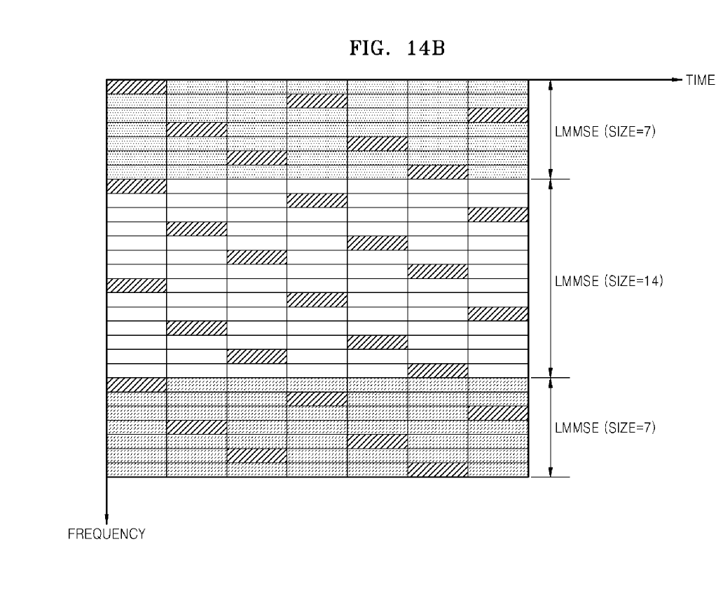

FIGS. 14A and 14B illustrate a channel estimation method according to an embodiment of the present invention.

When channel estimation is performed in an up-link, a CPE that uses an AMC subchannel transmits a collection of adjacent subcarriers, and thus the AMC subchannel can be estimated using pilots transmitted to adjacent subcarriers from a CPE that uses an AMC subchannel according to a Linear Minimum Mean Square Error (LMMSE) technique (where the size of a partition is 14). However, a diversity subchannel cannot be estimated using the LMMSE technique, because CPEs transmit subcarriers placed at different locations. Accordingly, the diversity subchannel can be estimated using pilots transmitted during 7 OFDMA symbols in units of subcarriers according to a least square (LS) technique.

When channel estimation is performed in a down-link, all of the CPEs can use all of the subcarriers transmitted, and thus both an AMC subchannel and a diversity channel can be estimated using all of the pilot symbols included in the band according to an LMMSE technique (where the size of a partition is 28).

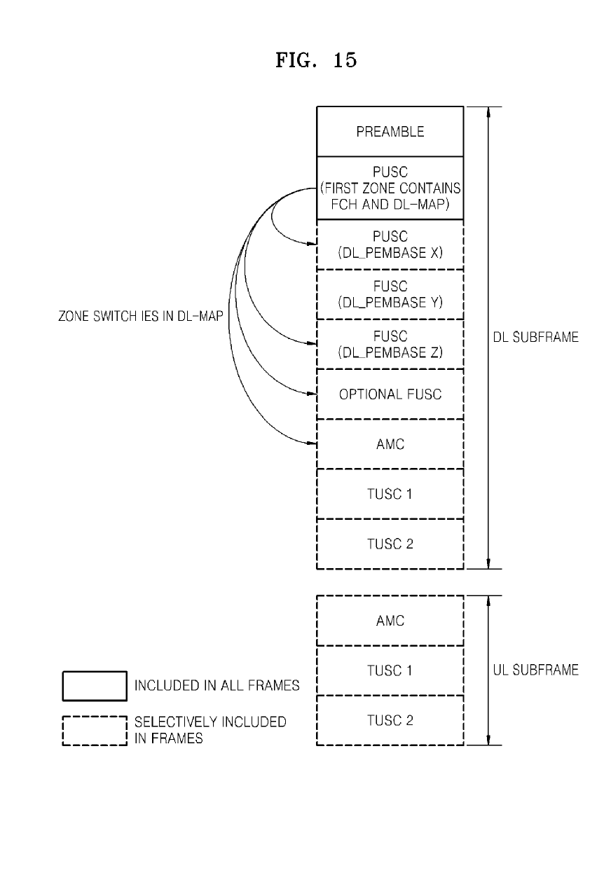

FIG. 15 illustrates an AMC subchannel in a standard 802.16. Referring to FIG. 15, a subframe is divided into a diversity subchannel and an AMC subchannel. This subframe structure is inefficient when the number of bands required by a user is less than that of usable bands included in an AMC zone, and is not easy to control the transmission power between the diversity subchannel and the AMC subchannel.

The standard 802.22 has a fixed channel environment, and thus it is more efficient to continuously allocate AMC subchannels in a favorable portion of an 6 MHz channel than in a particular symbol. In a down-link, AMC subchannels provide better performance by using the same SNRs (or power) than diversity subchannels. Therefore, part of the transmission power of an AMC subchannel may be used for a diversity subchannel of a CPE placed far from a base station.

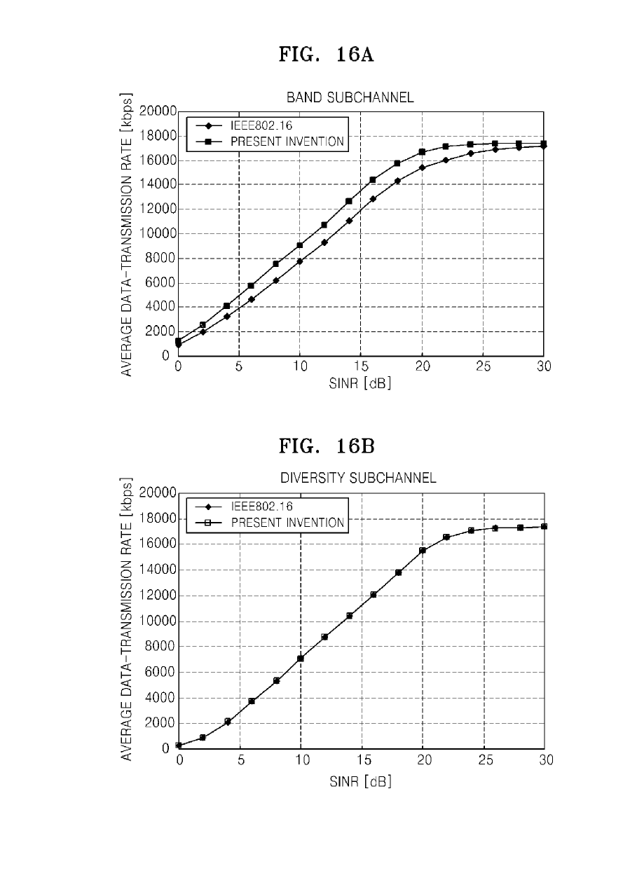

FIGS. 16A and 16B are graphs showing data transmission efficiency obtained by a subchannel allocating method according to the present invention and data transmission efficiency obtained by a subchannel allocating method supported by the standard 802.16.

FIGS. 16A and 16B illustrate experimental results of subchannel composition (allocation) performed in a Wireless Rural Area Network (WRAN) channel model B under a condition that 12 user terminals (namely, 6 user terminals to which band subchannels are allocated and 6 user terminals to which diversity subchannels are allocated) are used, 10 OFDMA symbols constitute a down stream (DS) subframe, and OFDM symbols constitute diversity subchannels and band subchannels in a 7:3 ratio. Referring to FIGS. 16A and 16B, compared with an existing method (which is supported by the standard 802.16) of forming diversity subchannels and band subchannels at different timings in a time domain, a method of simultaneously forming two types of subchannels in the frequency domain according to the present invention increases the transmission rate of band subchannels while maintaining the transmission rate of diversity subchannels.

As described above, in the method according to the present invention, an OFDM system divides a physical frequency resource into a plurality of bands and forms band subchannels each comprised of adjacent subcarriers included in specific bands and diversity subchannels each comprised of distributed subcarriers distributed over the whole frequency domain, thereby efficiently and simultaneously allocating the band subchannels and the diversity subchannels to the whole frequency resource according to various channel environments of users.

In order to achieve this, adjacent subcarrier bands, distributed subcarrier bands, and mixed bands are used, and thus even when a larger number of band subchannels than diversity subchannels are allocated, the diversity subchannels allow a diversity gain to be maintained. In addition, the whole frequency resource can be flexibly composed of a combination of various band subchannels or diversity subchannels. In particular, when the subcarriers of a diversity subchannel use frequency hopping, the diversity characteristics can be maximized.

The subchannel allocating method according to the present invention can be applied to subchannel allocation in an up-link or a down-link.

The present specification includes all of the matters stated in U.S. Patent Application No. 60/893,898 filed on Mar. 9, 2007.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers of ordinary skill in the art to which the present invention pertains.

The terminology used herein is for the purpose of describing particular embodiments only and is not intended to be limiting of the invention.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A subchannel allocating method for data transmission and reception in an orthogonal frequency division multiple access (OFDMA) system, the method comprising:
dividing a whole frequency band into a plurality of bands and allocating adjacent subcarriers and distributed subcarriers to each of the bands in a predetermined ratio; and
forming a band subchannel comprised of adjacent subcarriers included in at least one band selected from among the plurality of bands and a diversity subchannel comprised of distributed subcarriers.

2. The subchannel allocating method of claim 1, wherein the plurality of bands are comprised of one of an adjacent subcarrier band comprised of adjacent subcarriers, a distributed subcarrier band comprised of distributed subcarriers, and a mixed band comprised of both adjacent subcarriers and distributed subcarriers.

3. The subchannel allocating method of claim 1, wherein the dividing of the frequency band and allocating of the subcarriers and distributed subcarriers comprises composing either adjacent subcarrier bands comprised of adjacent subcarriers or mixed bands comprised of both adjacent subcarriers and distributed subcarriers with regard to the bands selected from among the plurality of bands on the basis of band information received from a user terminal.

4. The subchannel allocating method of claim 3, wherein the number of adjacent subcarriers included in the mixed band and the locations of the adjacent subcarriers are identically or differently set for each of the mixed bands in the whole frequency band.

5. The subchannel allocating method of claim 3, wherein the number of adjacent subcarriers included in the mixed band and the locations of the adjacent subcarriers are identically or differently set for specific band during predetermined periods of time.

6. The subchannel allocating method of claim 1, wherein the forming of the band subchannel and the diversity subchannel comprises:
forming the band subchannel by allocating adjacent subcarriers of the at least one band selected from among the plurality of bands on the basis of band information received from a user terminal; and
forming the diversity subchannel by allocating distributed subcarriers of bands including the distributed subcarriers.

7. The subchannel allocating method of claim 6, wherein the band subchannel is formed of adjacent subcarriers that are allocated during predetermined periods of time of the selected bands.

8. The subchannel allocating method of claim 6, wherein the diversity subchannel is formed by applying a frequency hopping in which distributed subcarriers having different subcarrier indices are allocated in each OFDMA symbol.

9. The subchannel allocating method of claim 1, wherein a ratio in which band subchannels and diversity subchannels are formed depends on the ratio in which adjacent subcarriers and distributed subcarriers are allocated to each of the bands.

10. The subchannel allocating method of claim 1, further comprising allocating the band subchannel to a user terminal close to a base station and the diversity subchannel to a user terminal far away from the base station.

11. The subchannel allocating method of claim 1, wherein the method is applied when users are fixed or move at low speed.

12. A data transceiving method performed by a terminal in an OFDMA system, the method comprising receiving one of a band subchannel and a diversity subchannel from a base station and transmitting data to and receiving data from the base station via the received subchannel,
wherein the band subchannel is comprised of adjacent subcarriers of at least one band selected from among a plurality of bands and the diversity subchannel is comprised of distributed subcarriers, each of the plurality of bands comprise adjacent subcarriers and distributed subcarriers in predetermined ratio.

13. The data transceiving method of claim 12, further comprising:
classifying the plurality of bands that constitute a whole frequency band into a plurality of band groups;
measuring channel characteristics of a signal received from the base station; and
selecting at least one band having high value of channel characteristics from the received signal and generating band information about the selected bands on the basis of band information of band groups to which the selected bands belong, wherein the band subchannel is received from the base station on the basis of the band information about the selected bands.

14. The data transceiving method of claim 13, wherein the band information is periodically generated and transmitted to the base station.

15. The data transceiving method of claim 13, wherein the band information about the selected bands comprises band indices and channel characteristics values of the selected bands.

16. A subchannel allocating apparatus for data transmission and reception in an OFDMA system, the apparatus comprising:
a band composing unit dividing a whole frequency band into a plurality of bands and allocating adjacent subcarriers and distributed subcarriers to each of the bands in a predetermined ratio; and
a subchannel forming unit forming a band subchannel comprised of adjacent subcarriers included in at least one band selected from among the plurality of bands and a diversity subchannel comprised of distributed subcarriers.

17. The subchannel allocating apparatus of claim 16, wherein the band composing unit composes either adjacent subcarrier bands comprised of adjacent subcarriers or mixed bands comprised of both adjacent subcarriers and distributed subcarriers with regard to the bands selected from among the plurality of bands on the basis of band information received from a user terminal.

18. The subchannel allocating apparatus of claim 16, wherein the subchannel forming unit forms the band subchannel by allocating adjacent subcarriers of the at least one band selected from among the plurality of bands on the basis of band information received from a user terminal, and forms the diversity subchannel by allocating distributed subcarriers of bands including the distributed subcarriers.

19. The subchannel allocating apparatus of claim 18, wherein the subchannel forming unit forms the band subchannel of adjacent subcarriers that are allocated during predetermined periods of time of the selected bands.

20. The subchannel allocating apparatus of claim 18, wherein the subchannel forming unit forms the diversity subchannel by applying frequency hopping in which distributed subcarriers having different subcarrier indices are allocated in each OFDMA symbol.

21. The subchannel allocating apparatus of claim 16, wherein a ratio in which band subchannels and diversity subchannels are formed depends on the ratio in which adjacent subcarriers and distributed subcarriers are allocated to each of the bands.

22. The subchannel allocating apparatus of claim 16, further comprising a subchannel allocating unit allocating the band subchannel to a user terminal close to a base station and the diversity subchannel to a user terminal far away from the base station.

23. A data transceiving terminal in an OFDMA system, the terminal comprising a transceiving unit receiving one of a band subchannel and a diversity subchannel from a base station and transmitting data to and receiving data from the base station via the received subchannel,
wherein the band subchannel is comprised of adjacent subcarriers of at least one band selected from among a plurality of bands and the diversity subchannel is comprised of distributed subcarriers, each of the plurality of bands comprise adjacent subcarriers and distributed subcarriers in predetermined ratio.

24. The data transceiving terminal of claim 23, further comprising:
a band defining unit classifying the plurality of bands that constitute a whole frequency band into a plurality of band groups;
a channel measuring unit measuring channel characteristics of a signal received from the base station; and
a feedback information generating unit selecting at least one band having high value of channel characteristics from the received signal and generating band information about the selected bands on the basis of band information of band groups to which the selected bands belong,
wherein the transceiving unit receives the band subchannel from the base station on the basis of the band information.

25. The data transceiving terminal of claim 24, wherein the band information is periodically generated and transmitted to the base station.
